(19) United States
(12) Patent Application Publication
(10) Pub. No.: US 2026/0037860 A1
(43) Pub. Date: Feb. 5, 2026

(54) PHONE AND ADDRESS ENCODING

(71) Applicant: INTUIT INC., Mountain View, CA (US)

(72) Inventors: Itay MARGOLIN, Tel Aviv (IL); Hadas BAUMER, Tel Aviv (IL); Omer WOSNER, Tel Aviv (IL)

(73) Assignee: INTUIT INC., Mountain View, CA (US)

(21) Appl. No.: 18/791,180

(22) Filed: Jul. 31, 2024

(51) Int. Cl. G06N 20/00

(52) U.S. Cl. CPC G06N 20/00

(57) ABSTRACT

An address encoder and a phone number encoder can be trained on training data including an address dataset, a phone number dataset, and information associating respective addresses in the address dataset with respective phone numbers in the phone number dataset as associated pairs. The training can be by a constrastive learning process such that respective distances between respective pairs of address vectors from the trained address encoder and phone number vectors from the trained phone number encoder are minimized for respective associated pairs. In production, the trained encoders can determine a production distance between a production address and a production phone number, and these results can be used to modify a production computing process.

### BACKGROUND

Neural networks (NNs) and large language models (LLMs) can be used for a variety of tasks, providing fast and useful results in many use cases. However, problems arise with encoding numbers and addresses using language trained models. Language trained models working with numbers and address can produce embeddings representing non informative features. For phone numbers, models that encode language features do not have the ability to detect numerical patterns well. Likewise, while addresses represent geographical locations, encoding them using language models to encode them can produce representations of the semantic meanings of the location names. This prevents leveraging their inert properties while using LLMs, which may have value in multiple use cases. Accordingly, users must choose between classical machine learning models that lack the multiple advantages of LLMs, or using LLMs without encoding the geographical features of phone numbers and/or addresses.

### BRIEF DESCRIPTIONS OF THE DRAWINGS

FIG. 1 shows an example phone and address encoding system according to some embodiments of the disclosure.

FIGS. 2A and 2B show an example training process according to some embodiments of the disclosure.

FIG. 3 shows an example production phone number and address encoding process according to some embodiments of the disclosure.

FIG. 4 shows an example fraud detection process according to some embodiments of the disclosure.

FIG. 5 shows an example entity detection process according to some embodiments of the disclosure.

FIGS. 6A-6C show an example optical character recognition process according to some embodiments of the disclosure.

FIG. 7 shows an example LLM prompt and response process according to some embodiments of the disclosure.

FIG. 8 shows a computing device according to some embodiments of the disclosure.

### DETAILED DESCRIPTION OF SEVERAL EMBODIMENTS

Systems and methods described herein can encode phone numbers and addresses into a new embedding space that embodies the real-world geographical characteristics of the phone numbers and addresses. By using data sets of matching physical addresses and phone numbers, systems and methods described herein can push their embeddings to be closer to the geographical matching information, thus creating an encoding mechanism that can surface geographical embedding representations. This may enable the usage of phone numbers and addresses together with other embeddings in LLMs and/or other machine learning (ML) systems while capturing their inert meanings.

The disclosed systems and methods can account for the fact that with phone numbers or addresses, the meaning is not present inside the data in a literal sense. For example, “123 Happy Street” is not a description of the actual location that can be understood inherently; reference to a map or other resource may be required. Moreover, the word “happy” is merely an indicator of a location and not a qualitative description. However, in many cases there is a connection between phone numbers and addresses. For example, phone number prefixes and area codes can correspond with geographic and/or political locations, as can zip codes within addresses. Accordingly, as described in detail below, phone numbers and addresses can be encoded in tandem, and the encoding networks may be trained to minimize distance between vectors commonly associated with similar locations.

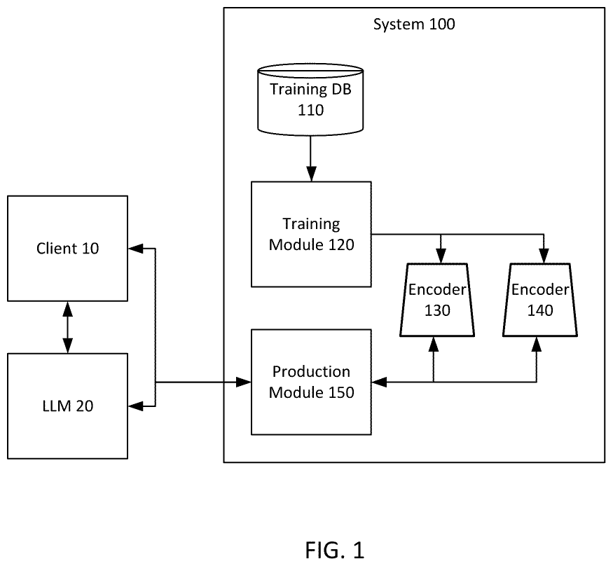

FIG. 1 shows an example phone and address encoding system 100 according to some embodiments of the disclosure. System 100 may include a variety of hardware, firmware, and/or software components that interact with one another and/or with external components, such as training database (DB) 110, training module 120, encoders 130 and 140, and/or production module 150. These elements are described in greater detail below, but in general, training module 120 may use training data from training DB 110 to train encoders 130 and 140. Once encoders 130 and 140 are trained, production module 150 can use encoders 130 and 140 to process data. For example, production module 150 can use encoders 130 and 140 to process data from client 10 in a variety of contexts described in detail below and/or to augment operations performed by large language model (LLM) 20 as described in detail below.

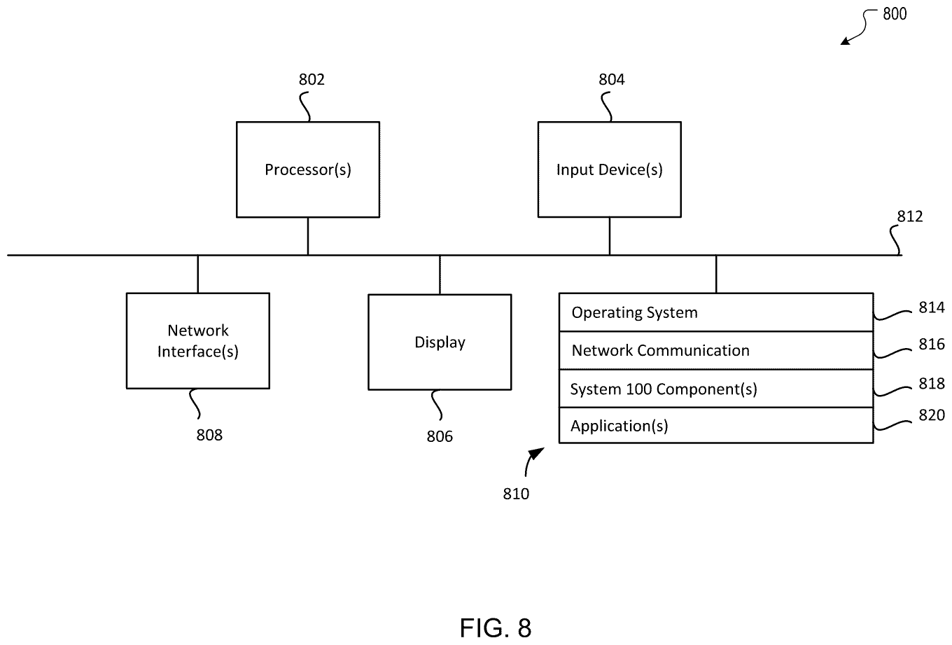

Some components within system 100 and/or external to system 100 may communicate with one another using networks. Some components may communicate with client 10 and/or LLM 20 through one or more networks (e.g., the Internet, an intranet, and/or one or more networks that provide a cloud environment). For example, as described in detail below, during production, production module 150 can process data received from or sent to client 10 and/or LLM 20 by the one or more networks. Each component may be implemented by one or more computers (e.g., as described below with respect to FIG. 8).

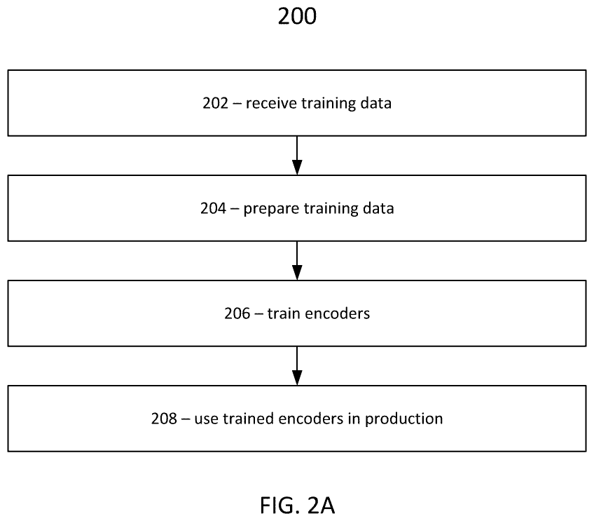

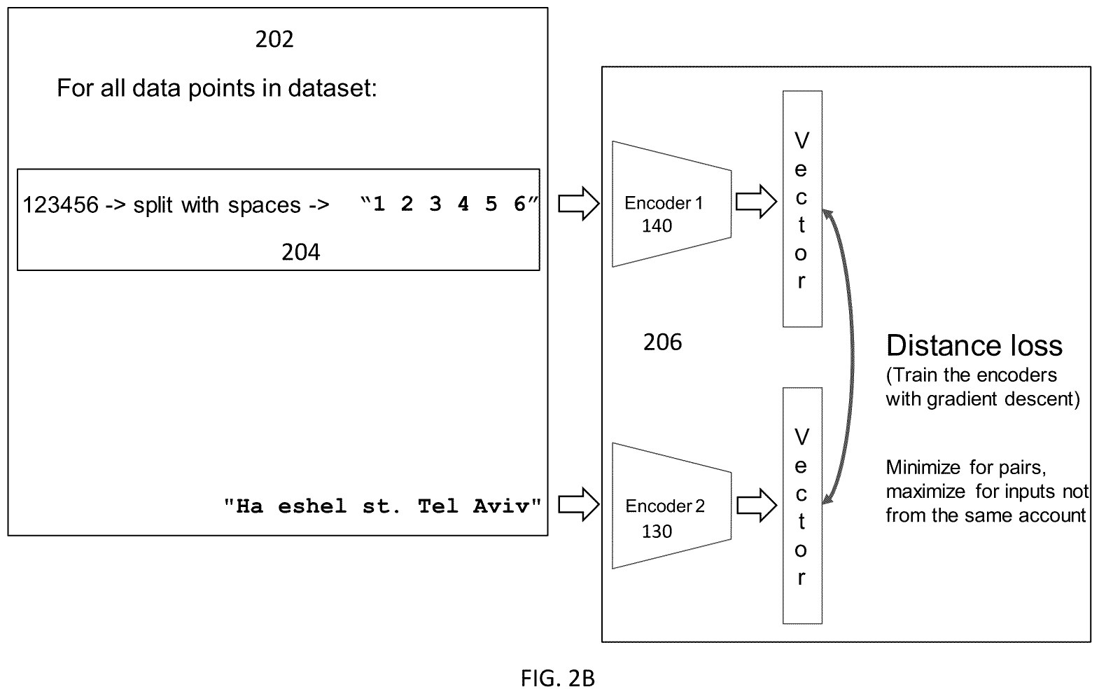

As described in detail below, system 100 can perform processing to detect and/or process phone number and/or address data to improve processing by other systems (e.g., client 10 and/or LLM 20) in a variety of ways. For example, FIGS. 2A-7 illustrate the functioning of the illustrated components in detail.

Elements illustrated in FIG. 1 (e.g., system 100 including training database 110, training module 120, encoders 130 and 140, and production module 150, detection LLM 20 and production LLM 30 (which may or may not be part of system 100), and/or client 10) are each depicted as single blocks for ease of illustration, but those of ordinary skill in the art will appreciate that these may be embodied in different forms for different implementations. For example, while client 10, LLM 20, and system 100 are depicted separately, any combination of these elements may be part of a combined hardware, firmware, and/or software element. Likewise, while training database 110, training module 120, encoders 130 and 140, and production module 150 are depicted as parts of a single system 100, any combination of these elements may be distributed among multiple logical and/or physical locations. Also, while one client 10, one LLM 20, and one system 100 (with one of each of training database 110, training module 120, encoders 130 and 140, and production module 150) are illustrated, this is for clarity only, and multiples of any of the above elements may be present. In practice, there may be single instances or multiples of any of the illustrated elements, and/or these elements may be combined or co-located.

In the following descriptions of how system 100 functions, several examples are presented. However, those of ordinary skill in the art will appreciate that these examples are merely for illustration, and system 100 and its methods of use and operation are extendable to other application and data contexts.

FIGS. 2A and 2B show an example training process 200 according to some embodiments of the disclosure. System 100 (e.g., training module 120 and/or training DB 110) can perform process 200 to train one or more encoders (e.g., encoder 130 and encoder 140). Once trained, the encoders can minimize distances between related phone numbers and addresses to enable various production tasks.

At 202, training module 120 can receive training data, for example from training DB 110. Training data can include, for example, an address dataset, a phone number dataset, and information associating respective addresses in the address dataset with respective phone numbers in the phone number dataset as associated pairs. The specific training data set can be formatted and/or sourced in a variety of ways, for example from a phone book, a customer database, etc.

At 204, training module 120 can prepare the training data received at 202. For example, in some embodiments training module 120 can insert spaces or non-numeric characters between neighboring digits in respective phone numbers in the phone number dataset. An example is shown in FIG. 2B, where training module 120 converts the number “123456” to the string “1 2 3 4 5 6” by adding spaces between each digit. Splitting digits by inserting spaces or other characters may solve a technical problem wherein most LLMs and encoders are configured to split numbers in chunks of three digits, whereas phone numbers are usually arranged in different digit counts (e.g., ten digits for a typical phone number in the United States (or 11 digits including the country code+1)). To make sure each digit is a different token, training module 120 can force separation by inserting spaces or other characters.

Returning to FIG. 2A, at 206, training module 120 can train encoders 130 and 140. For example, encoder 130 can be an address encoder, and encoder 140 can be a phone number encoder. Training module 120 can train address encoder 130 and phone number encoder 140 on the training data by a constrastive learning process such that respective distances between respective pairs of address vectors from the trained address encoder 130 and phone number vectors from the trained phone number encoder 140 are minimized for respective associated pairs. In at least some embodiments, address encoder 130 and phone number encoder 140 can be multi-head attention transformers (e.g., BERT or similar). Training module 120 can train address encoder 130 on the address data in the training data and can train phone number encoder 140 on the phone number data in the training data (which may be modified as described above). The training can cause the distances between the representations of addresses and phone numbers to be low if respective pairs of addresses and phone numbers are associated with the same account and high otherwise (i.e., contrastive learning). Those skilled in the art may appreciate that similar contrastive learning training is used to train zero shot image classifiers such as CLIP and/or SimCLR, although in the disclosed embodiments the training uses different data (e.g., address and phone number data) and is geared toward different applications as described in detail below.

FIG. 2B shows a specific example of the training, where a dataset is received at 202 and phone numbers are split at 204, as described above. Modified phone numbers (e.g., “1 2 3 4 5 6”) are sent to one encoder 140, and addresses “e.g., “Ha eshel st. Tel Aviv”) are sent to another encoder 130, and the encoders are trained by a gradient descent process so that distances between output vectors thereof are minimized for pairs (e.g., minimized if “123456” is the true phone number for “Ha eshel st. Tel Aviv” according to the training data) and maximized otherwise.

Returning to FIG. 2A, at 208, trained encoders 130 and 140 can be used in production, for example by production module 150 and/or other systems, as described in detail with respect to the following figures. Some examples of possible production uses for trained encoders 130 and 140 can include, but are not limited to, fraud detection, identity matching, optical character recognition (OCR) enhancement, and/or LLM enhancement.

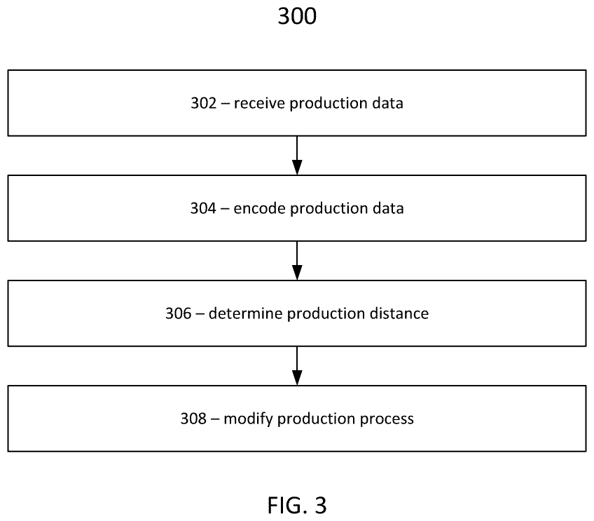

FIG. 3 shows an example production phone number and address encoding process 300 according to some embodiments of the disclosure. By performing process 300, system 100 can use trained encoders 130 and 140 in production (e.g., at 208 of process 200). Based on encoding processing 300, one or more production processes may be modified, as described in several examples below. For example, production module 150 can receive a phone number and address pair as the production data, process the phone number and address using the respective phone number and address encoders, and find the distance between vectors output by the encoders. Based on this distance, other processing can be initiated, modified, and/or improved.

At 302, production module 150 may receive production data. The production data can include at least one production phone number and at least one production address. Respective phone numbers and respective addresses may be associated with one another as respective phone number and address pairs. For example, client 10 can provide the production data as at least one input to system 100 in connection with processing being performed by client 10, where information about the distance between the phone number and address of a pair can be used in the processing being performed by client 10.

At 304, production module 150 may use trained encoders 130 and 140 to encode the production data. For example, address encoder 130 and phone number encoder 140 can encode the at least one input into at least one vector, where address encoder 130 encodes the address portion of the input and phone number encoder encodes the phone number portion of the input. In at least some embodiments, production module 150 may perform pre-processing on the phone number in a manner similar to that described above, for example inserting spaces or other characters between digits, before the encoding by phone number encoder 140. After encoding, the production data may be encoded into at least one address vector and at least one phone number vector.

At 306, production module 150 may determine a production distance production distance between the production address and the production phone number. As described above, the address encoder 130 and phone number encoder 140 can be trained to minimize distance between pairs that are related and maximize distance otherwise. Accordingly, production module 150 can compare the production distance between vector pairs produced at 304 with a threshold. A production distance below the threshold can indicate a likely relationship between the phone number and the address (e.g., phone number and address belong to the same entity), for example.

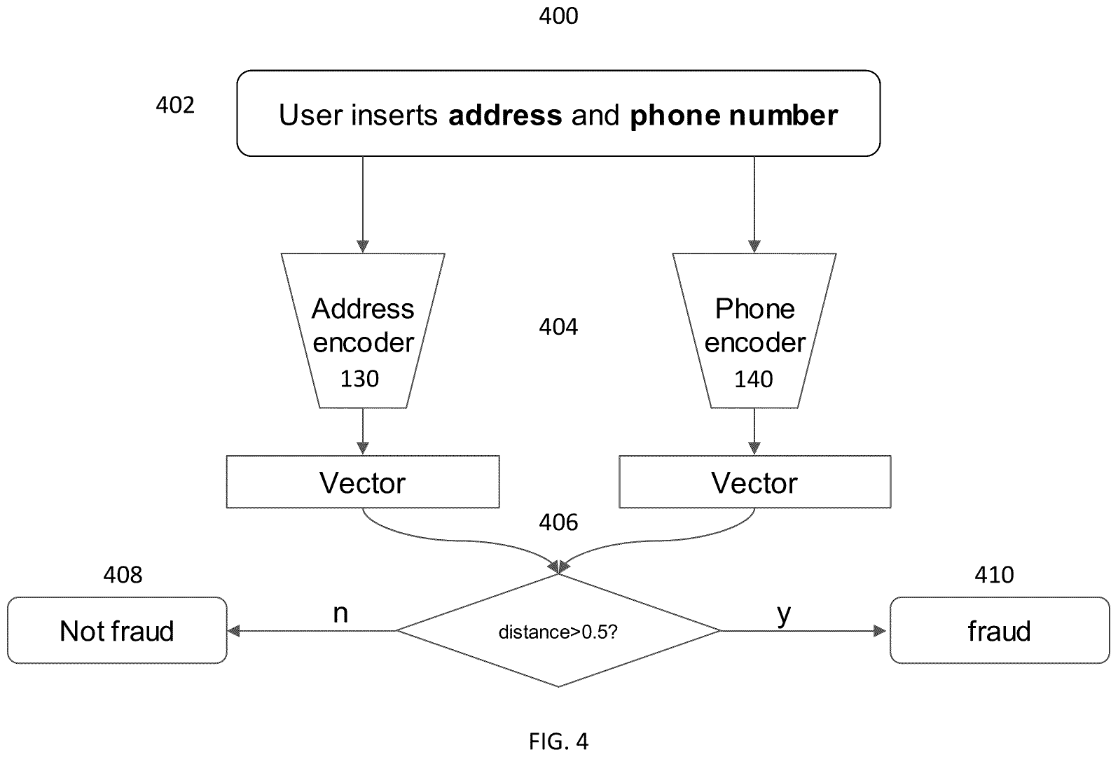

At 308, production module 150 may modify a production computing process in accordance with the production distance and/or may cause or trigger such modification. This phase of process 300 may vary by use case and is the processing whereby the disclosed embodiments can improve other computing processes. In some cases, a first modification may be performed in response to the production distance being above the threshold and/or a second modification may be performed in response to the production distance being below the threshold. The following figures (FIGS. 4-7) illustrate several examples of how production computing processes may be modified consistent by the disclosed systems and methods.

FIG. 4 shows an example fraud detection process 400 according to some embodiments of the disclosure. In process 400, element 402 is similar to element 302 of process 300, where production module 150 receives production data. Here, the production data can include an address and phone number input by a user of client 10, however it may be possible for the address and phone number to come from other sources. Element 404 is similar to element 304 of process 300, where production module 150 encodes the data. Here, the user-entered address and phone number are encoded by the address encoder 130 and phone number encoder 140, respectively. Element 406 is similar to element 306 of process 300, where the distance between output vectors from address encoder 130 and phone number encoder 140 is determined and compared against a threshold (here, 0.5).

Elements 408 and 410 represent a modification of a production computing process (e.g., as in element 308 of process 300). Here, the production computing process is a fraud detection process or a portion thereof. As shown in FIG. 4, if the distance is low (e.g., less than the threshold value), at 408 a processor performing the fraud detection process may determine that the address and phone number pair is not, in itself, indicative of fraud. Alternatively, if the distance is high (e.g., greater than the threshold value), at 410 the processor performing the fraud detection process may determine that the address and phone number pair is at least potentially indicative of fraud. In response, the processor can generate a fraud alert or elevate a fraud status for processes with multiple fraud indicators.

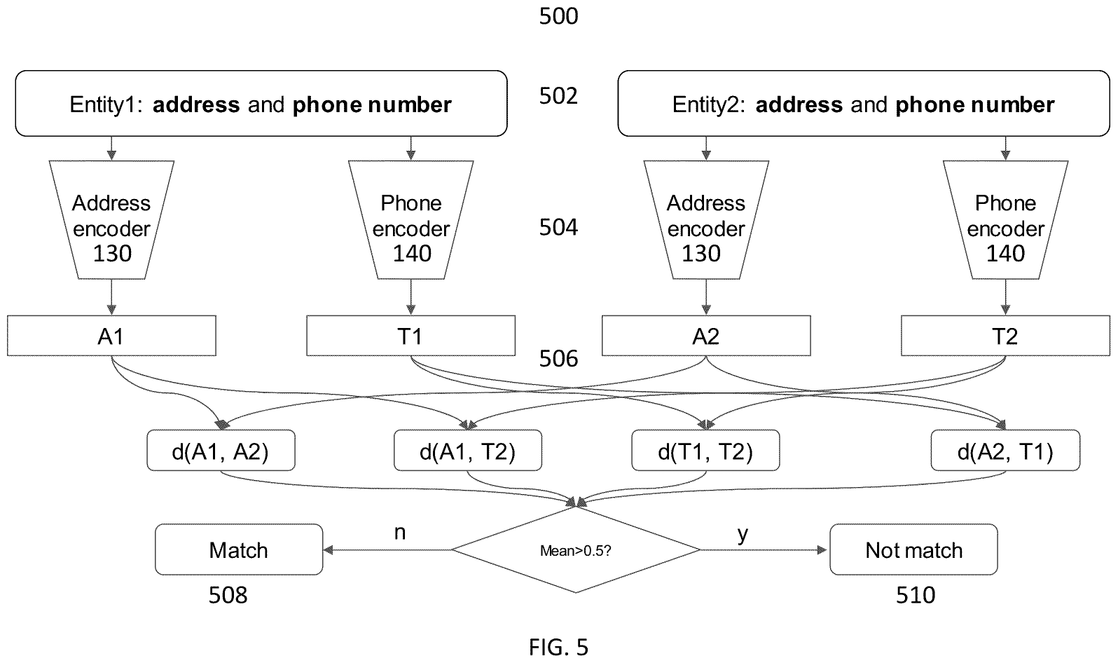

FIG. 5 shows an example entity detection process 500 according to some embodiments of the disclosure. In process 500, element 502 is similar to element 302 of process 300, where production module 150 receives production data. Here, the production data can include an address and phone number for a first entity (“entity1”) and an address and phone number for a second entity (“entity2”). These inputs may come from client 10 in some embodiments, though it may be possible for the address and phone number to come from other sources. Element 504 is similar to element 304 of process 300, where production module 150 encodes the data. Here, the respective addresses and phone numbers of each entity are encoded by the address encoder 130 and phone number encoder 140, respectively. Element 506 is similar to element 306 of process 300, where distances between output vectors from address encoder 130 and phone number encoder 140 are determined and compared against a threshold (here, 0.5). Unlike process 300, multiple distances are determined. Specifically, production module 150 can determine a distance for each pair of vectors. Moreover, the threshold may be compared against a mean of the multiple distances.

Elements 508 and 510 represent a modification of a production computing process (e.g., as in element 308 of process 300). Here, the production computing process is an entity detection process or a portion thereof. As shown in FIG. 5, if the mean distance is low (e.g., less than the threshold value), at 508 a processor performing the entity detection process may determine that entity1 and entity2 may be the same entity or related entities. Alternatively, if the distance is high (e.g., greater than the threshold value), at 510 the processor performing the entity detection process may determine that entity1 and entity2 may be more likely to be different entities. In response, the processor can provide an indication of its results to a user (e.g., via a user interface of client 10), update a record, or perform some other task in response to the determining. For example, an identity matching model can predict if two records are tied to the same identity. This can be useful for correcting data entry issues (e.g., “Mountain View” in one address entry in a database, “Mountainview” in another), matching entities with entries in different databases having different data formats, associating multiple phone numbers with a single address (e.g., for businesses with multiple phone numbers), and/or a variety of other tasks.

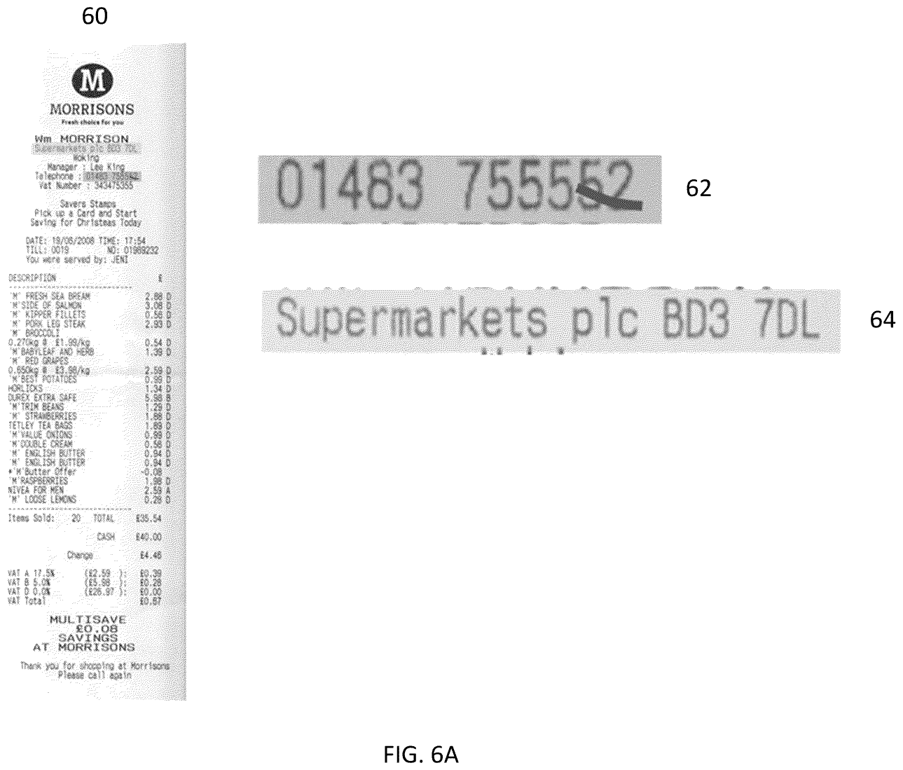

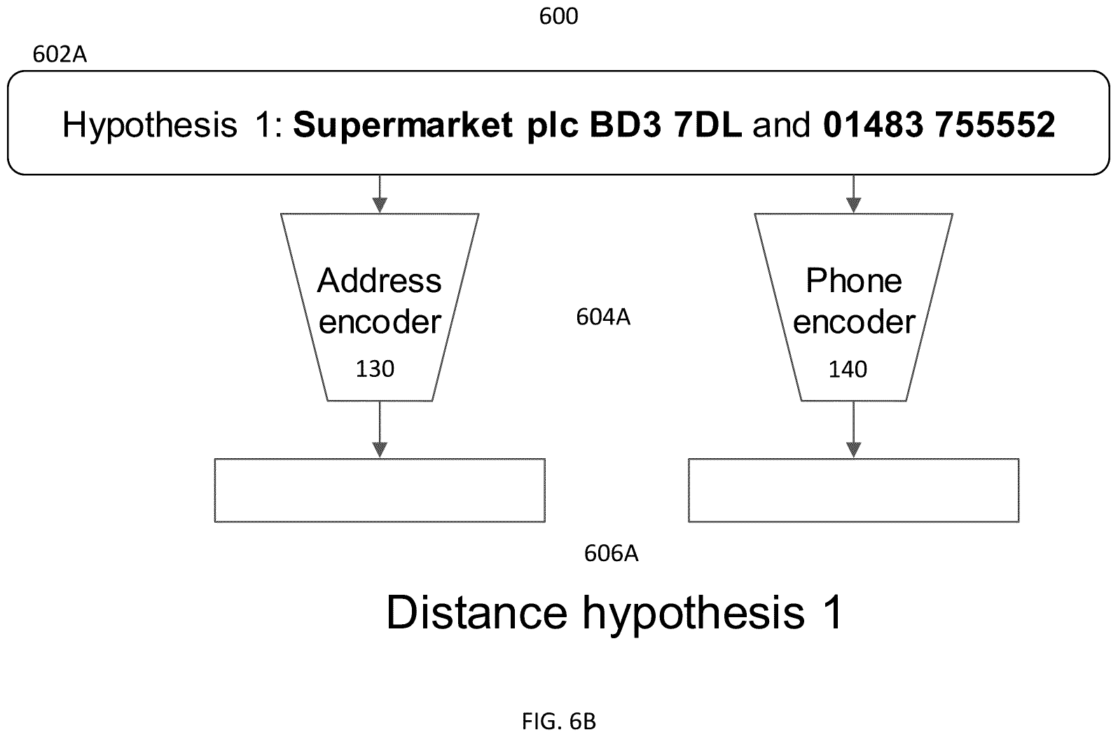

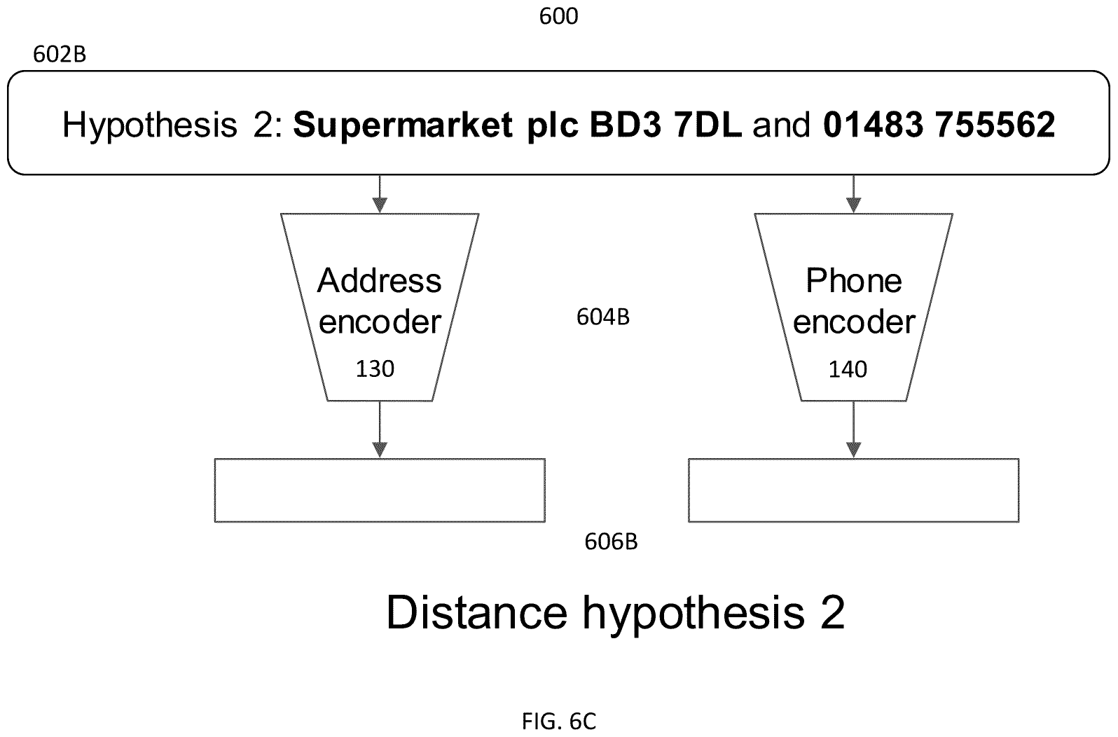

FIGS. 6A-6C show an example OCR process 600 according to some embodiments of the disclosure. FIG. 6A presents an issue that may occur with OCR wherein a document includes characters that are obscured or otherwise difficult to read. Here, receipt 60 includes phone number 62 and address 64. However, as shown, part of phone number 62 is obscured by a stray mark on receipt 60. To determine how to recognize the obscured character(s), a processor performing the OCR process can generate multiple hypothetical entries for the obscured character(s).

In FIG. 6B, element 602A is similar to element 302 of process 300, where production module 150 receives production data. Here, the production data can include a first hypothesis for the address and the phone number generated by an OCR process. Element 604A is similar to element 304 of process 300, where production module 150 encodes the data. Here, the first hypothetical address and phone number are encoded by the address encoder 130 and phone number encoder 140, respectively. Element 606A is similar to element 306 of process 300, where the distance between output vectors from address encoder 130 and phone number encoder 140 is determined.

In FIG. 6C, element 602B is similar to element 302 of process 300, where production module 150 receives production data. Here, the production data can include a second hypothesis for the address and the phone number generated by an OCR process. The second hypothesis may differ from the first hypothesis by including a different possible option for the obscured character(s). Element 604B is similar to element 304 of process 300, where production module 150 encodes the data. Here, the second hypothetical address and phone number are encoded by the address encoder 130 and phone number encoder 140, respectively. Element 606B is similar to element 306 of process 300, where the distance between output vectors from address encoder 130 and phone number encoder 140 is determined.

In order to select a hypothesis, (e.g., as a modification such as in element 308 of process 300) the processor performing OCR may choose the hypothesis having a lower distance as determined at 606A and 606B. That is, the lower distance may be more likely to belong to a correct address and phone number pair, meaning the obscured phone number is more likely to have been recognized correctly in the selected hypothesis. Accordingly, the processor performing OCR may provide a final OCR result including the chosen hypothesis.

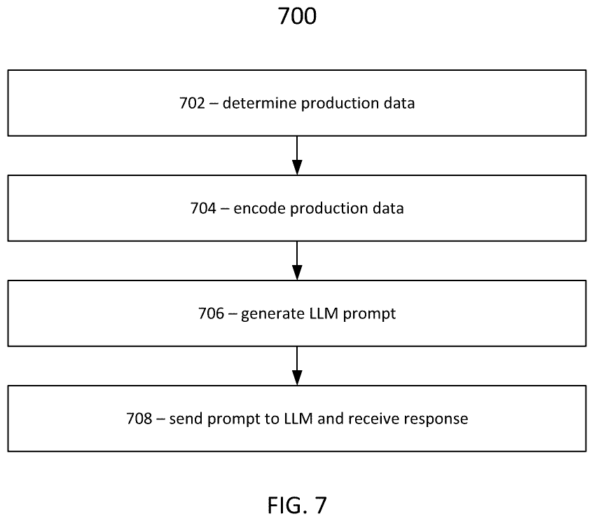

FIG. 7 shows an example LLM prompt and response process 700 according to some embodiments of the disclosure. As noted above, an address name such as “Happy Street” does not inherently contain the relevant meaning, which can create problems for LLMs. For example, an LLM might proceed, with an input of “Happy Street,” to provide a response leveraging training data encompassing the concept of happiness, rather than the location itself. This may happen because LLMs generally encode each word into its own token, so “happy” is a token with its own meaning. By performing process 700, system 100 can provide improved prompts to LLMs wherein an address and/or phone number is encoded with its geographic and/or political meaning, rather than or in addition to its linguistic meaning.

At 702, production module 150 can determine relevant production data for further processing. For example, in some cases production module 150 can receive a prompt (e.g., from client 10) for an LLM (e.g., LLM 20) that includes an address and/or phone number that is clearly labeled as an address and/or phone number. In this case, production module 150 can extract the labeled address and/or phone number. In other cases, production module 150 can extract the address and/or phone number through additional processing. For example, production module 150 can provide the text of the prompt to LLM 20 with an instruction to extract the address and/or phone number and receive the result.

At 704, production module 150 can encode the production data. For example, production module 150 can generate an address vector for any address in the prompt using address encoder 130, a phone number vector for any phone number in the prompt using phone number encoder 140, or a combination thereof.

At 706, production module 150 can generate an LLM prompt. The prompt can include the vector(s) generated at 704. Accordingly, the prompt encodes not only the words themselves that are included within the address, but also a meaning indicated by the presence of a vector encapsulating the entire address as an address.

At 708, production module 150 can send the prompt generated at 706 to LLM 20. The response from LLM 20 can be dependent on the encoding of, and therefore the meaning indicated by, the vector (i.e., the recognition that the data is an address). Accordingly, if required, LLM 20 can provide an answer that recognizes a geographic and/or political location. Production module 150 can receive the response from LLM 20 and use it, for example by sending the response to client 10. In other cases, LLM 20 can send the response to client 10 or otherwise use the response itself without passing it through system 100.

FIG. 8 shows a computing device 800 according to some embodiments of the disclosure. For example, computing device 800 may function as system 100 or any portion(s) thereof, or multiple computing devices 800 may function as system 100.

Computing device 800 may be implemented on any electronic device that runs software applications derived from compiled instructions, including without limitation personal computers, servers, smart phones, media players, electronic tablets, game consoles, email devices, etc. In some implementations, computing device 800 may include one or more processors 802, one or more input devices 804, one or more display devices 806, one or more network interfaces 808, and one or more computer-readable mediums 810. Each of these components may be coupled by bus 812, and in some embodiments, these components may be distributed among multiple physical locations and coupled by a network.

Display device 806 may be any known display technology, including but not limited to display devices using Liquid Crystal Display (LCD) or Light Emitting Diode (LED) technology. Processor(s) 802 may use any known processor technology, including but not limited to graphics processors and multi-core processors. Input device 804 may be any known input device technology, including but not limited to a keyboard (including a virtual keyboard), mouse, track ball, and touch-sensitive pad or display. Bus 812 may be any known internal or external bus technology, including but not limited to ISA, EISA, PCI, PCI Express, NuBus, USB, Serial ATA or FireWire. In some embodiments, some or all devices shown as coupled by bus 812 may not be coupled to one another by a physical bus, but by a network connection, for example. Computer-readable medium 810 may be any medium that participates in providing instructions to processor(s) 802 for execution, including without limitation, non-volatile storage media (e.g., optical disks, magnetic disks, flash drives, etc.), or volatile media (e.g., SDRAM, ROM, etc.).

Computer-readable medium 810 may include various instructions 814 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 804; sending output to display device 806; keeping track of files and directories on computer-readable medium 810; controlling peripheral devices (e.g., disk drives, printers, etc.) which can be controlled directly or through an I/O controller; and managing traffic on bus 812. Network communications instructions 816 may establish and maintain network connections (e.g., software for implementing communication protocols, such as TCP/IP, HTTP, Ethernet, telephony, etc.).

System 100 components 818 may include instructions for performing the processing described herein. For example, system 100 components 818 may provide instructions for performing any and/or all of processes 200 and/or 300, and/or other processing as described above. Application(s) 820 may be an application that uses or implements the outcome of processes described herein and/or other processes. In some embodiments, the various processes and/or portions thereof may also be implemented in operating system 814.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In some cases, instructions, as a whole or in part, may be in the form of prompts given to a large language model or other machine learning and/or artificial intelligence system. As those of ordinary skill in the art will appreciate, instructions in the form of prompts configure the system being prompted to perform a certain task programmatically. Even if the program is non-deterministic in nature, it is still a program being executed by a machine. As such, “prompt engineering” to configure prompts to achieve a desired computing result is considered herein as a form of implementing the described features by a computer program.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method comprising:
receiving, by at least one processor, training data including an address dataset, a phone number dataset, and information associating respective addresses in the address dataset with respective phone numbers in the phone number dataset as associated pairs;
training, by the at least one processor, an address encoder and a phone number encoder on the training data by a constrastive learning process such that respective distances between respective pairs of address vectors from the trained address encoder and phone number vectors from the trained phone number encoder are minimized for respective associated pairs;
determining, by the at least one processor, a production distance between a production address and a production phone number using the trained address encoder and the trained phone number encoder; and
modifying, by the at least one processor, a production computing process in accordance with the production distance.

2. The method of claim 1, wherein the address encoder and the phone number encoder are multi-head attention transformers.

3. The method of claim 1, further comprising preparing, by the at least one processor, the training data prior to the training, the preparing including inserting spaces or non-numeric characters between neighboring digits in respective phone numbers in the phone number dataset.

4. The method of claim 1, further comprising comparing, by the at least one processor, the production distance with a threshold, wherein the modifying comprises selecting a first modification in response to the production distance being above the threshold or selecting a second modification in response to the production distance being below the threshold.

5. The method of claim 1, wherein the modifying comprises generating a fraud alert or elevating a fraud status in response to a value of the production distance.

6. The method of claim 1, wherein the modifying comprises determining that respective entities associated with at least one of the production address and the production phone number are related or identical entities in response to a value of the production distance.

7. The method of claim 1, wherein the modifying comprises selecting one of a plurality of optical character recognition hypotheses as correct in response to a value of the production distance.

8. A system comprising:
at least one processor; and
at least one non-transitory computer-readable medium storing instructions that, when executed by the at least one processor, cause the at least one processor to perform processing comprising:
receiving training data including an address dataset, a phone number dataset, and information associating respective addresses in the address dataset with respective phone numbers in the phone number dataset as associated pairs;
training an address encoder and a phone number encoder on the training data by a constrastive learning process such that respective distances between respective pairs of address vectors from the trained address encoder and phone number vectors from the trained phone number encoder are minimized for respective associated pairs;
determining a production distance between a production address and a production phone number using the trained address encoder and the trained phone number encoder; and
modifying a production computing process in accordance with the production distance.

9. The system of claim 8, wherein the address encoder and the phone number encoder are multi-head attention transformers.

10. The system of claim 8, wherein the processing further comprises preparing the training data prior to the training, the preparing including inserting spaces or non-numeric characters between neighboring digits in respective phone numbers in the phone number dataset.

11. The system of claim 8, wherein the processing further comprises comparing the production distance with a threshold, wherein the modifying comprises selecting a first modification in response to the production distance being above the threshold or selecting a second modification in response to the production distance being below the threshold.

12. The system of claim 8, wherein the modifying comprises generating a fraud alert or elevating a fraud status in response to a value of the production distance.

13. The system of claim 8, wherein the modifying comprises determining that respective entities associated with at least one of the production address and the production phone number are related or identical entities in response to a value of the production distance.

14. The system of claim 8, wherein the modifying comprises selecting one of a plurality of optical character recognition hypotheses as correct in response to a value of the production distance.

15. A method comprising:
receiving, by at least one processor, at least one input including at least one of an address and a phone number;
encoding, by the at least one processor, the at least one input into at least one vector using an address encoder and a phone number encoder trained by a constrastive learning process such that respective distances between respective pairs of address vectors and phone number vectors are minimized for respective associated pairs of the address vectors and phone number vectors;
providing, by the at least one processor, the at least one vector as at least a portion of a prompt to a large language model (LLM); and
receiving, by the at least one processor, a response from the LLM, wherein the response is dependent upon the encoding of the at least one vector.

16. The method of claim 15, further comprising preparing, by the at least one processor, the at least one input prior to the encoding, the preparing including inserting spaces or non-numeric characters between neighboring digits in the phone number.

17. The method of claim 15, wherein the encoding of the at least one vector indicates at least one meaning of at least one of the address and the phone number to the LLM.

18. The method of claim 15, wherein the address encoder and the phone number encoder are multi-head attention transformers.

19. The method of claim 15, further comprising training, by the at least one processor, the address encoder and the phone number encoder.

20. The method of claim 19, wherein the training comprises:
receiving, by the at least one processor, training data including an address dataset, a phone number dataset, and information associating respective addresses in the address dataset with respective phone numbers in the phone number dataset as associated pairs; and
training, by the at least one processor, the address encoder and the phone number encoder on the training data by the constrastive learning process such that respective distances between respective pairs of address vectors from the trained address encoder and phone number vectors from the trained phone number encoder are minimized for respective associated pairs.
